(19) United States
(12) Patent Application Publication
(10) Pub. No.: US 2016/0144549 A1
(43) Pub. Date: May 26, 2016

(54) SLOT DIE FOR EXTRUSION DEVICE

(71) Applicant: KAUTEX TEXTRON GMBH & CO. KG, Bonn (DE)

(72) Inventors: Joachim ECKHARDT, Bonn (DE); David SCHENKEL, Bonn (DE)

(21) Appl. No.: 14/901,648

(22) PCT Filed: Jun. 11, 2014
(86) PCT No.: PCT/EP2014/062107

§ 371 Date: Dec. 28, 2015

(30) Foreign Application Priority Data
Jun. 28, 2013 (DE) 10 2013 010 788.1

(51) Int. Cl. B29C 47/16; B29C 47/00; B29B 11/10

(52) U.S. Cl. CPC B29C 47/16; B29B 11/10; B29C 47/0021; B29K 2101/12

(57) ABSTRACT

The invention discloses a slot die (10) for an extrusion device for the extrusion of preforms (1) in web or strip form from thermoplastic material which comprises a die gap (11) extending transversely to a direction of extrusion and intended for delivering a preform (1). The slot die (10) is characterized in that it comprises at least one adjusting element (12), which is arranged peripherally in the die gap (11), limits a widthwise extent (SB) of the die gap (11) and is mounted continuously displaceably and/or pivotably with respect to the die gap (11). The widthwise extent (SB) of the die gap (11) is dynamically and continuously variable by displacing and/or pivoting the adjusting element (12), so that a widthwise extent (VB) of a preform (1) extruded from the slot die (10) is continuously and infinitely variable over the length of extrusion thereof.

The invention relates to a slot die for an extrusion device for the extrusion of preforms in web or strip form from thermoplastic material.

The invention also relates to an extrusion die head for an extrusion device for the extrusion of preforms in web or strip form with a corresponding slot die or with a number of corresponding slot dies.

In addition, the invention relates to an extrusion device for the extrusion of preforms in web or strip form from thermoplastic material with a corresponding extrusion die head.

Finally, the invention relates to a method for producing a plastic article with the aid of extruded preforms in strip or web form from thermoplastic material, preferably using a corresponding extrusion device.

In the suspended extrusion of preforms from an extrusion die head, the weight of the preform and the plasticity of the thermoplastic material cause the problem that the extruded preform is drawn in with increasing length, i.e. that the widthwise extent thereof is greater in the region of the die gap of the extrusion die head and in the region of the freely suspended end than the widthwise extent in the middle of the linear extent of the preform. This in turn has the consequence that, to completely line a part-cavity of an outer mould of a multipart moulding tool, the preform has to be extruded with a greater width. When two mutually opposite outer moulds are closed and the preforms moulded in the respective part-cavities are fused together, a relatively great amount of unwanted thermoplastic material is left overhanging. This overhanging material must be removed in an additional working step, for example after the fusing process, from the plastic article formed. Furthermore, a relatively large amount of scrap material is generated in this way.

It is known from the prior art to grip suspended, drawn-in extrudates with a gripper, the gripper being designed to draw out the extrudate widthwise. However, the preforms obtained in this way have an unwantedly trapezoidal contour.

Furthermore, it is also known from the prior art to reduce the drawing-in effect by increasing the wall thickness of the preform, which however leads to an increased material requirement, and consequently to an increased shot weight. This approach to a solution accordingly has commercial disadvantages.

DE 10 2007 025 296 discloses an apparatus for the extrusion blow moulding of plastic articles with a multipart moulding tool and a device for the extrusion of preforms in web or strip form from thermoplastic material with an extrusion die head and a method for producing a plastic article with the aid of extruded preforms in strip or web form from thermoplastic material. The melt outlet of the extrusion die head is designed as a die gap which can be adjusted transversely to the direction of extrusion and parallel to a breadthwise extent and extends in a straight line. For this purpose, the die gap is bounded at least on one side directly by a number of segments which can be adjusted independently of one another transversely to the direction of extrusion and parallel to the breadthwise extent of the die gap, the segments making it possible for the breadth and/or width of the die gap to be adjusted in stages or steps. A preform extruded from the extrusion die head may consequently have a variable wall thickness and a variable and graduated width.

Although a preform extruded by means of the apparatus known from DE 10 2007 025 296 may have a variable width over its length, the side edges of the preform thus produced have unwanted graduations. These graduations in the material must also be removed in a separate working step from the plastic article formed, and furthermore undesired scrap material is also generated.

The object on which the present invention is based is to provide an improved slot die, the use of which in an extrusion device for the extrusion of preforms in web or strip form from thermoplastic material makes it possible to produce plastic articles with a reduced amount of scrap material, with a low shot weight of the preforms and with fewer method steps.

This object is achieved according to the invention by a slot die with the features specified in claim 1. Advantageous refinements are specified in the subclaims.

The invention is also based on the object of providing a method that avoids the disadvantages described above.

This object is achieved according to the invention by a method with the features specified in claim 11. Advantageous refinements are specified in the subclaims thereof.

To be more specific, the object on which the invention is based is achieved by a slot die for an extrusion device for the extrusion of preforms in web or strip form from thermoplastic material which comprises a die gap extending transversely to a direction of extrusion and intended for delivering a preform, the slot die being characterized in that it comprises at least a first adjusting element, which is arranged peripherally in the die gap, limits a widthwise extent of the die gap and is mounted continuously displaceably and/or pivotably with respect to the die gap, the widthwise extent of the die gap being dynamically and continuously variable by displacing and/or pivoting the first adjusting element, so that a widthwise extent of a preform extruded from the slot die is continuously and infinitely variable over the length of extrusion thereof.

Dynamic displacement and/or pivoting means in this connection that the adjusting element is displaced and/or pivoted during the extrusion of the preform.

By means of the slot die according to the invention, it is possible to adapt the width or the widthwise extent of the extruded preform continuously and dynamically over the length of extrusion thereof. As a result, it is possible to pre-empt a drawing-in of the preform. For example, the die gap width can be set to a prescribed value at the beginning of an operation for the extrusion of a preform, and be increased subsequently during the extrusion operation up to a maximum width, whereupon the width of the die gap is subsequently reduced again up to the end of the extrusion operation. On account of the force of the weight, the preform that is initially preformed in a bulging manner in side view is thus pulled straight.

It is therefore possible for creating a plastic article to adapt the width of the preform/preforms to the outer moulds of a multipart moulding tool, considerably less excess thermoplastic material being present in the corresponding end regions of the preforms, so that less material is required for producing the plastic article and less scrap material is generated. Furthermore, the thickness of the preform can also be reduced, since the thickness does not have to be increased to avoid drawing-in of the suspended preform. This is so because drawing-in is pre-compensated by being pre-empted, i.e. by the dynamic adaptation of the die gap width. The slot die according to the invention also offers advantages from commercial aspects, since the shot weight of the preforms can be reduced for the aforementioned reasons, so that less material can be used for producing a plastic article. In addition, when the slot die according to the invention is used in an extrusion device, it is possible that, after the extrusion of the preforms and/or after the joining/fusing together of the preformed preforms, excess material has to be removed from the plastic article thus created, for example by cutting off. Consequently, the cycle time for producing a plastic article is also reduced by using the slot die according to the invention.

The slot die preferably comprises a further adjusting element, which is arranged peripherally in the die gap, limits the widthwise extent of the die gap and is mounted continuously adjustably and/or pivotably with respect to the die gap. The two adjusting elements are in this case arranged lying opposite one another, so that a first adjusting element limits one side of the die gap, whereas the other, second adjusting element limits the other side of the die gap peripherally. The widthwise extent of the die gap is dynamically and continuously variable by displacing and/or pivoting the adjusting elements, so that the widthwise extent of a preform extruded from the slot die is continuously and infinitely variable over the length of extrusion thereof on two side edges thereof.

A correspondingly designed slot die allows the forming of a drawn-in waist of the extruded preform to be further improved and compensated or prevented more exactly since both sides of the preform are provided with a corresponding preforming.

In this case, the two adjusting elements protruding peripherally into the die gap may be dynamically and continuously made to move article-specifically independently of one another, so that a different contour can be imparted to one side of the preform than to the opposite side of the preform. This may be advantageous for example if the preform has a differing wall thickness over the widthwise extent thereof, so that the forming of a drawn-in waist would not be formed symmetrically in the preform. Consequently, the uneven weight distribution of the preform, and consequently the uneven lengthening of it, could also be specifically pre-compensated.

The adjusting element is preferably mounted pivotably about a pivot axis extending perpendicularly to the direction of extrusion and perpendicularly to the widthwise extent of the die gap and thus can be pivoted about this pivot axis at least partially into the die gap and at least partially out of it, so that the widthwise extent of the die gap can be dynamically and continuously reduced and/or increased.

Both adjusting elements are preferably mounted pivotably about a pivot axis respectively extending and oriented perpendicularly to the direction of extrusion and perpendicularly to the widthwise extent of the die gap, the two adjusting elements being able to be pivoted about their respective pivot axis at least partially into the die gap and at least partially out of it, so that the widthwise extent of the die gap can be dynamically and continuously reduced and/or increased.

A corresponding refinement of the slot die is possible particularly simply in structural terms and, furthermore, the adjusting element/adjusting elements can be driven particularly easily and power-efficiently by means of an adjusting device or two adjusting devices. To receive the adjusting element or the adjusting elements, one side plate or both side plates of the slot die is/are of a split form, so that the respective adjusting elements can be fitted between the split side plates. Alternatively, the side plates may respectively have a slit-shaped clearance, in which the adjusting element/adjusting elements is/are freely movable.

The adjusting element is preferably mounted displaceably in a direction of displacement parallel to the widthwise extent of the die gap, the widthwise extent of the die gap being reduced by pushing the adjusting element into the die gap, and the widthwise extent of the die gap being increased by pulling the adjusting element out from the die gap.

Both adjusting elements are preferably mounted displaceably in directions of displacement parallel to the widthwise extent of the die gap, the widthwise extent of the die gap being reduced by pushing the adjusting elements into the die gap, and the widthwise extent of the die gap being increased by pulling the adjusting elements out from the die gap.

A corresponding embodiment of the slot die offers the advantage that it can also be produced particularly simply in structural terms and that the adjusting elements can be easily activated by means of a corresponding adjusting device.

The adjusting element preferably has a side edge running obliquely in relation to the die gap and directed towards the die gap and is displaceable parallel to the direction of extrusion. By displacing the adjusting element in a first direction, the side edge is pushed into the die gap, so that the widthwise extent of the die gap is reduced, and by displacing the adjusting element in a second direction, which is opposed to the first direction, the side edge is pushed out or pulled out from the die gap, so that the widthwise extent of the die gap is increased.

Both adjusting elements preferably have in each case a side edge running obliquely in relation to the die gap and directed towards the die gap and are respectively displaceable parallel to the direction of extrusion. By displacing the adjusting elements in a first direction, the side edges are pushed into the die gap, so that the widthwise extent of the die gap is reduced, and by displacing the adjusting elements in a second direction, which is opposed to the first direction, the side edges are pulled out from the die gap, so that the widthwise extent of the die gap increases.

It is also conceivable that the side edge of an adjusting element or the side edges of both adjusting elements has/have an uneven side edge or an uneven profile, so that the widthwise extent of the die gap is changed correspondingly by displacing an adjusting element in the direction of extrusion. It is thus possible for example that a concave shaping of the side edge of the adjusting element or the adjusting elements and a continuous and dynamic displacement of the adjusting elements in the direction of extrusion during the extrusion operation have the effect of imparting a corresponding convex side edge to the preforms, so that the drawing-in of the preforms is pre-compensated or avoided by the adjusting elements in a particularly easy way. This is so because the widthwise extent of a correspondingly extruded preform is less at the beginning and end thereof than in the middle region thereof.

The object on which the invention is based is also achieved by a method for producing a plastic article with the aid of extruded preforms in strip or web form from thermoplastic materials, the method comprising the following method steps:
plasticating thermoplastic material in an extruder;
feeding the plasticated material to a die gap of an extrusion die head, the die gap having an elongate, approximately rectangular cross section;
dynamically and continuously adjusting a gap width of the die gap by means of an adjusting element arranged peripherally in the die gap during the extrusion in such a way that an infinitely variable width is imparted to the preform over the length thereof; and
further processing the extrudate emerging from the die gap within a multipart moulding tool in the first heat with the application of gas pressure and/or a vacuum to form a plastic article.

In the dynamic and continuous adjustment of the gap width of the die gap by means of the adjusting element arranged peripherally in the die gap during the extrusion, preferably such an infinitely variable width is imparted to the preform over the length thereof that, in the fully extruded preform, at least one longitudinal edge runs perpendicularly to the transverse edge thereof in side view.

The dynamic and continuous adjustment of the gap width of the die gap by means of two adjusting elements arranged peripherally in the die gap and lying opposite one another during the extrusion is preferably accomplished in such a way that an infinitely variable width is imparted to the preform over the length thereof.

Preferably, in this case the fully extruded preform is rectangular in side view and the side edges of the fully extruded preform run parallel to one another.

Further advantages, details and features of the invention emerge below from the exemplary embodiments explained. Specifically:

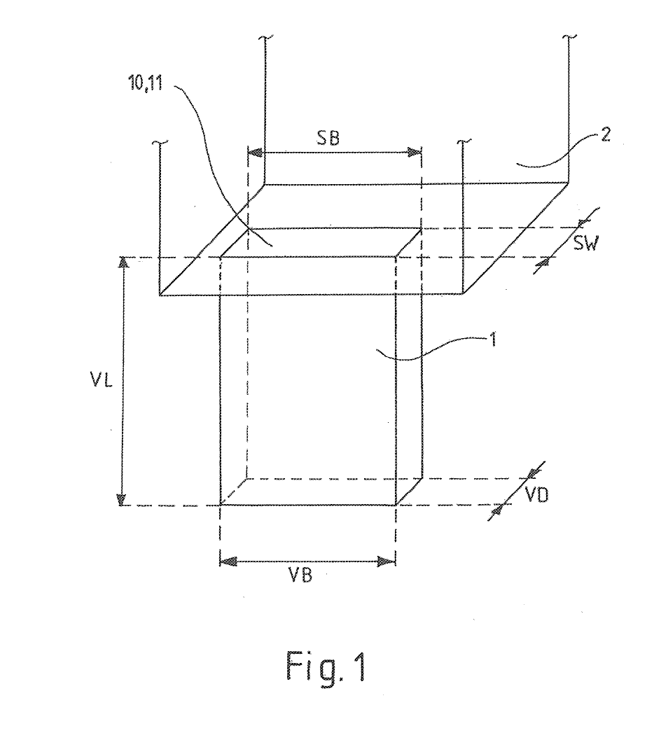

FIG. 1 shows a schematic view of an extrusion die head for the definition of the nomenclature used;

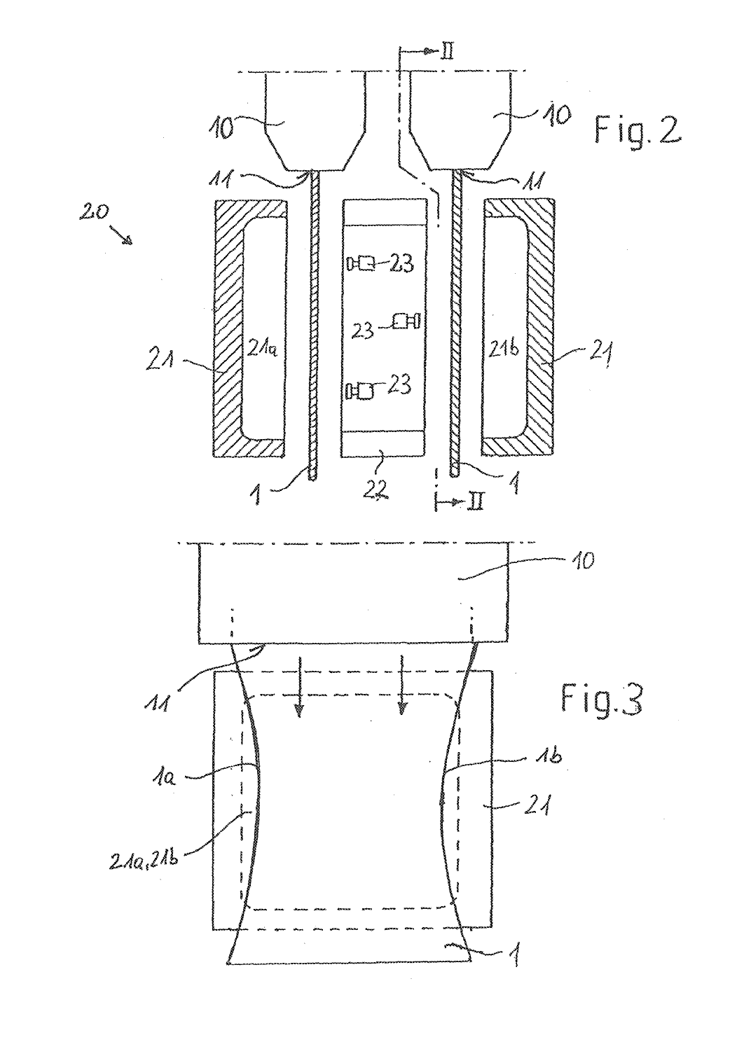

FIG. 2 shows a schematic view of an extrusion device and a multipart moulding tool arranged underneath the extrusion device, adjusting elements being passively connected;

FIG. 3 shows a section along the lines II in FIG. 2;

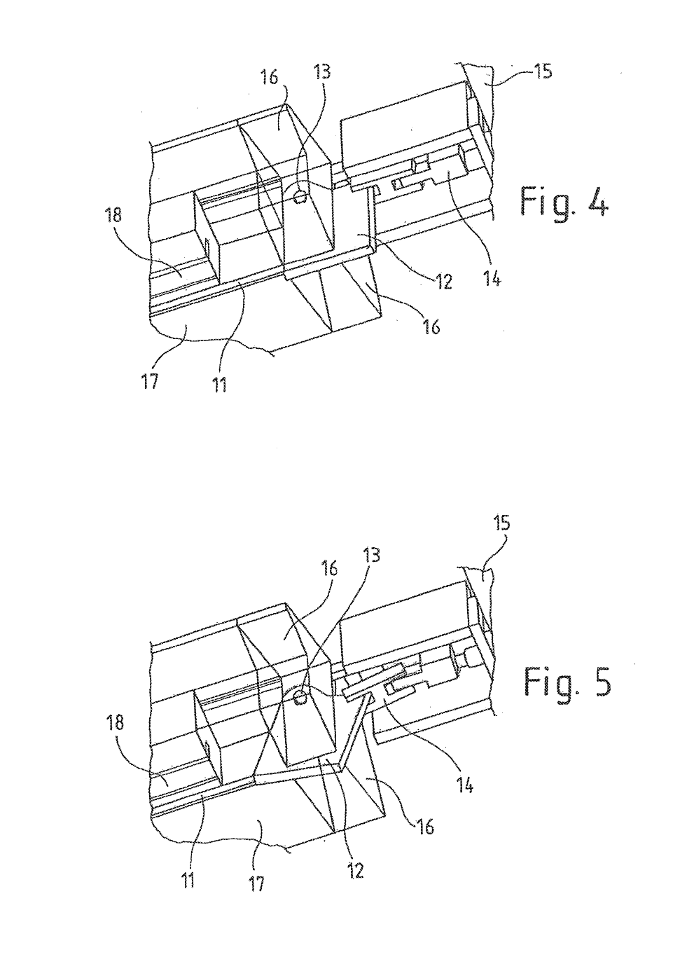

FIG. 4 shows a three-dimensional representation of a slot die according to the invention with the adjusting element in the neutral position;

FIG. 5 shows the slot die represented in FIG. 4, the adjusting element protruding further into the die gap, so that the width of the die gap is reduced by means of the adjusting element;

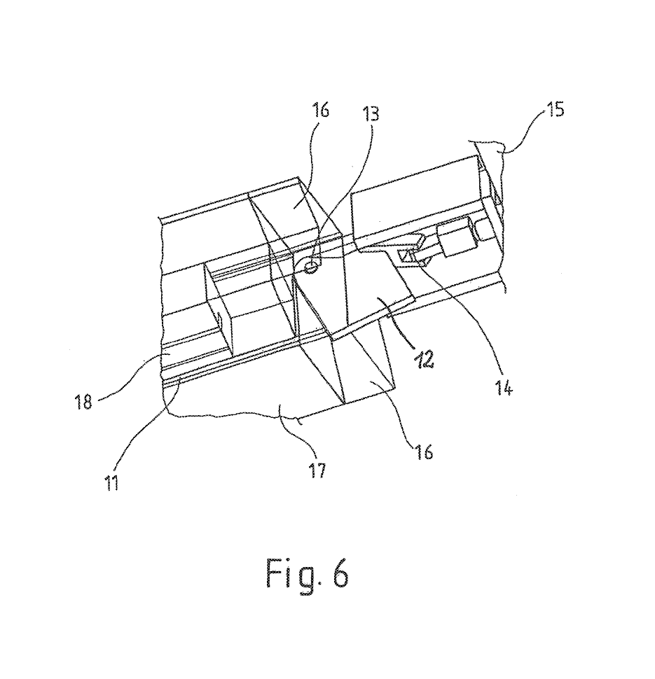

FIG. 6 shows the slot die represented in FIGS. 4 and 5, the adjusting element protruding less into the die gap, so that the width of the die gap is increased by means of the adjusting element; and

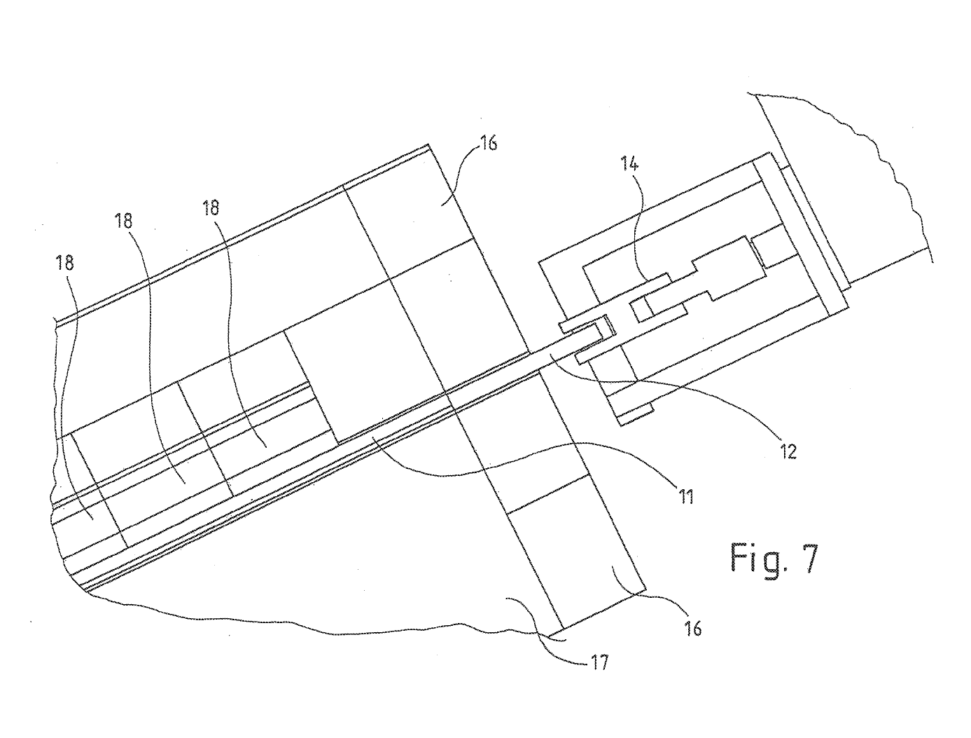

FIG. 7 shows the slot die represented in FIG. 4, in a plan view of the die gap thereof.

In the description that follows, the same reference signs denote the same components or the same features, so that a description of a component given with reference to one figure also applies to the other figures, thereby avoiding a repeated description.

In FIG. 1, an extrusion die head 2 is schematically represented for the definition of the nomenclature used. The extrusion die head 2 comprises a die gap or a flow gap 11, which is formed as a slot die 10. The die gap 11 has in this case a width or a widthwise extent SB and a breadth or breadthwise extent SW.

A preform 1 extruded from the extrusion die head 2 consequently has a thickness or thickness extent VD corresponding to the breadth SW and a width or widthwise extent VB corresponding to the width SB. In dependence on the extrusion speed and the extrusion time, the preform 1 also has a corresponding length or linear extent VL.

In FIG. 2, an extrusion device with two slot dies 10 and a multipart moulding tool 20 arranged underneath the extrusion device is schematically represented. The preforms 1 are extruded in a suspended manner from the slot dies 10, i.e. following gravitational force. The slot dies 10 are part of an extrusion die head (not represented), which is charged with molten thermoplastic material from an extruder in a known way.

As represented for example in FIG. 2, the preforms 1 are extruded in the form of webs or sheets between the opened parts of the moulding tool 20. The moulding tool 20 comprises two outer moulds 21 and a centre mould 22. The outer moulds 21 respectively have in this case part-cavities 21a and 21b, into which the preforms 1 are drawn or pressed and which respectively determine the later outer contour of the finished article. The production of an article may take place for example by the preforms 1 first being respectively extruded between the opened outer moulds 21 and the centre mould 22, whereupon the outer moulds 21 are closed against the centre mould 22. The preforms 1 are subsequently moulded into the part-cavities 21a, 21b either by applying gas pressure and/or by generating a negative pressure.

The centre mould 22 comprises extendable and retractable component holders 23, by means of which it is possible during or after the moulding of the preforms 1 in the part-cavities 21a, 21b to introduce built-in parts into the article to be produced as a hollow body. Subsequently, the centre mould 22 is made to move between the outer moulds 21 transversely to the direction of extrusion, either into the plane of the drawing or out of it. The outer moulds 21 are moved towards one another in the sense of a closing movement, so that the shell-shaped semifinished products contained in them are fused together to form a container with a peripheral seam.

The preforms 1 may be respectively provided or formed as a multilayered co-extrudate.

The part-cavities 21a, 21b and the geometry of the outer moulds 21 are greatly simplified in the exemplary embodiment represented. Depending on the article to be produced, both part-cavities 21a, 21b may have a highly fissured contour. In addition, the outer moulds 21 do not necessarily have to have an approximately rectangular cross section, as represented in FIG. 3.

It can be seen from FIG. 3, which represents a section along the lines II of FIG. 2, that, in the suspended extrusion of preforms 1 from an extrusion die head, the weight of the preform 1 and the plasticity of the thermoplastic material thereof cause the problem that the extruded preform 1 is drawn in, i.e. that the widthwise extent thereof is greater in the region of the die gap 11 of the extrusion die head and in the region of its freely suspended end than the widthwise extent in the middle of the linear extent of the preform 1.

A correspondingly drawn-in preform would form if, in the case of the slot die according to the invention, the adjusting elements still to be explained were connected passively, i.e. that the widthwise extent SB of the die gap 1 were not varied during the extrusion. The operating principle of the slot die is explained further below with reference to FIGS. 4 to 7.

The drawing-in of the preform 1 would have the consequence that, to completely line a part-cavity 21a, 21b of the outer moulds 21, the preform 1 would have to be extruded with a greater width VB. When the two mutually opposite outer moulds 21 are closed and the preforms 1 moulded in the respective part-cavities 21a, 21b are fused together, a relatively great amount of unwanted thermoplastic material would be left overhanging the part-cavities 21a, 21b. In the situation represented in FIG. 3, the drawing-in of the preform 1 is so great that the longitudinal edges 1a, 1b of the preform 1 no longer cover the entire part-cavity 21a, 21b of the outer mould in side view. Consequently, during the moulding of the preforms 1, the part-cavities 21a, 21b could no longer be completely lined by the preform 1. It is directly evident from this that, in order that the entire part-cavity 21a, 21b can be lined by the preform 1, the width SB of the die gap 11 must be chosen to be correspondingly wider.

In FIGS. 4 to 6, a three-dimensional representation of the slot die according to the invention is shown as seen obliquely from below, in FIG. 4 an adjusting element 12 being in a neutral position, whereas in FIG. 5 the adjusting element 12 protrudes into the die gap 11, so that the width of the die gap 11 is reduced by means of the adjusting element 12, and in FIG. 6 the adjusting element 12 protruding less far into the die gap 11, so that the width of the die gap 11 is increased by means of the adjusting element 12.

FIG. 7 shows a plan view of the underside of the slot die 10.

In all of FIGS. 4 to 7, only one end region of the slot die 10 according to the invention is represented, it being possible for the other end region of the slot die 10, opposite from this end region, to be formed correspondingly.

The slot die 10 comprises two adjusting elements 12 in the form of adjusting plates 12, which are arranged peripherally on the slot die 10 and limit the die gap 11 peripherally, so that the widthwise extent SB of the die gap 11 is limited by the adjusting elements 12. The two adjusting elements 12 are arranged lying opposite one another. The slot die 10 comprises two side plates 16, which in the exemplary embodiments represented are of a two-piece form. Between the two-piece side plates 16, an adjusting element 12 is respectively mounted pivotably about a pivot axis 13 extending perpendicularly to the direction of extrusion and perpendicularly to the widthwise extent SB of the die gap 11. The adjusting element 12 can consequently be freely pivoted in the gap that is formed between the two-part side plates 16.

For pivoting the adjusting elements 12, they are respectively connected by way of a drive linkage 14 to an actuating device 15 in the form of a servo-hydraulic cylinder. By applying a force directed in the direction of the die gap 11 by means of the actuating device 15, a torque is exerted on the adjusting element 12, so that the adjusting element 12 protrudes at least partially into the die gap 11, whereby the widthwise extent SB of the die gap 11 is reduced.

The pivoting into and out of the die gap 12 by means of the actuating device 15 and the drive linkage 14 is possible during the operation of extruding the preform 1, so that the widthwise extent SB of the die gap 11, and consequently the widthwise extent VB of the preform 1, is continuously and infinitely variable during the extrusion operation.

It can also be seen from FIGS. 4 to 7 that the slot die 10 comprises a multiplicity of lamella units 18 or slides 18, which are arranged lying opposite a limiting plate 17 of the slot die 10.

The limiting plate 17 is arranged between the side plates 16 and extends perpendicularly to the side plates 16. The respective slides 18 can be actuated by way of actuating devices (not represented), so that the breadthwise extent SW of the die gap 11 is variable by means of the slides 18 during the operation of extruding the preform 1. Consequently, not only can a continuous widthwise extent VB be imparted to the preform 1 over the linear extent VL thereof, but also the thickness VD of the preform can be continuously and dynamically adapted in dependence on the position of the slides 18, so that, when a correspondingly formed and shaped preform 1 is applied to a part-cavity 21a, 21b and the preform 1 is subsequently moulded, corresponding regions of the preform 1 can be pre-compensated with respect to thinning-out by corresponding stretching.

With the slot die 10 according to the invention, it is possible to impart to an extruded preform 1 a desired widthwise extent VB, which is adapted to correspond to a contour of a part-cavity. Furthermore, a drawing-in of the preform 1 can be correspondingly counteracted, in that the widthwise extent SB of the die gap 11 is set to a predetermined value at the beginning of an operation of extruding a preform 1, the widthwise extent SB of the die gap 11 being increased as the extrusion of the preform 1 progresses, by correspondingly adjusting the adjusting elements 12, and subsequently, towards the end of the extrusion operation, the widthwise extent SB of the die gap 11 being reduced again by pivoting the adjusting elements 12 into the die gap 11. On account of the force of the weight of the preform 1, a preform 1 that is correspondingly initially formed in a convex or bulging manner is pulled straight again, so that it has a rectangular form in side view, so that the corresponding side edges 1a, 1b of the preform 1 run parallel to one another. To this extent, there are no restrictions with regard to the shaping of the preform.

### LIST OF DESIGNATIONS

1 Preform

1a, 1b Side edge (of the preform)

10 Slot die

11 Die gap/flow gap (of the slot die)

12 Adjusting element (of the slot die)

13 Pivot axis (of the adjusting element)

14 Drive linkage (for the adjusting element)

15 Actuating device/servo-hydraulic cylinder (for the adjusting element)

16 Side plate (of the slot die)

17 Limiting plate (of the slot die)

18 Lamella unit/slide (for manipulation of the plate thickness)

20 Moulding tool

21 Outer moulds

21a, 21b Part-cavities (of the outer moulds)

22 Centre moulds

23 Component holder

SB Width (widthwise extent) of the die gap

SW Breadth (breadthwise extent) of the die gap

VB Width (widthwise extent) of the preform

VD Thickness (thickness extent) of the preform

VL Length (linear extent) of the preform

1. Slot die for an extrusion device for the extrusion of preforms in web or strip form from thermoplastic material comprising a die gap extending transversely to a direction of extrusion and intended for delivering a preform, wherein
the slot die comprises at least one adjusting element, which is arranged peripherally in the die gap, limits a widthwise extent (SB) of the die gap and is mounted continuously displaceably and/or pivotably with respect to the die gap; and
the widthwise extent (SB) of the die gap is dynamically and continuously variable by displacing and/or pivoting the adjusting element, so that a widthwise extent (VB) of a preform extruded from the slot die is continuously and infinitely variable over the length of extrusion thereof
characterized by the following features:
the adjusting element has a side edge running obliquely in relation to the die gap and directed towards the die gap;
the adjusting element is displaceable parallel to the direction of extrusion (ER);
by displacing the adjusting element in a first direction, the side edge is pushed into the die gap, so that the widthwise extent (SB) of the die gap is reduced; and
by displacing the adjusting element in a second direction, the side edge is pushed out from the die gap, so that the widthwise extent (SB) of the die gap is increased.

2. Slot die according to claim 1, characterized by the following features:
the slot die comprises a further adjusting element, which is arranged peripherally in the die gap, limits the widthwise extent (SB) of the die gap and is mounted continuously displaceably and/or pivotably with respect to the die gap;
the two adjusting elements are arranged lying opposite one another;
the widthwise extent (SB) of the die gap is dynamically and continuously variable by displacing and/or pivoting the adjusting elements, so that the widthwise extent (VB) of a preform extruded from the slot die (10) is continuously and infinitely variable over the length of extrusion thereof on two side edges thereof;
both adjusting elements have in each case a side edge running obliquely in relation to the die gap and directed towards the die gap;
the adjusting elements are displaceable parallel to the direction of extrusion (ER);
by displacing the adjusting elements in a first direction, the side edges are pushed into the die gap, so that the widthwise extent (SB) of the die gap is reduced; and
by displacing the adjusting elements in a second direction, the side edges are pushed out from the die gap, so that the widthwise extent (SB) of the die gap increases.

3.-8. (canceled)

9. Extrusion die head for an extrusion device for the extrusion of preforms in web or strip form, characterized in that a melt outlet of the extrusion die head is designed as a slot die that is adjustable transversely to the direction of extrusion according to claim 1.

10. Extrusion device for the extrusion of preforms in web or strip form from thermoplastic material, comprising an extrusion die head according to claims 9.

11.-15. (canceled)
